(19) United States
(12) Patent Application Publication
(10) Pub. No.: US 2019/0277045 A1
(43) Pub. Date: Sep. 12, 2019

(54) METHOD FOR CONSTRUCTING WALL-LIKE STRUCTURE

(71) Applicant: Yuta HIRAYAMA, Koshigaya-shi (JP)

(72) Inventor: Yuta HIRAYAMA, Koshigaya-shi (JP)

(21) Appl. No.: 16/135,862

(22) Filed: Sep. 19, 2018

(30) Foreign Application Priority Data
Mar. 7, 2018 (JP) 2018-040306

(51) Int. Cl. E04G 21/04; B33Y 10/00; B33Y 30/00; B29C 64/106; B29C 64/236; B29C 64/209; E04G 21/16

(52) U.S. Cl. CPC E04G 21/04; B33Y 10/00; B33Y 30/00; E04G 21/167; B29C 64/236; B29C 64/209; B29C 64/106

(57) ABSTRACT

A method for constructing a wall-like structure, the wall-like structure (100) including a pair of layered structural walls (10a and 10b) that are spaced apart from each other and that have a structure in which strip-shaped cured layers are laid, the method including a first step of forming a pair of strip-shaped cured layers (1) by discharging a curable material from two mutually spaced-apart portions of a self-propelled type material deposition apparatus (2) that is moving, and a second step of forming a new strip-shaped cured layer (1) on each of the pair of strip-shaped cured layers (1) by discharging the curable material onto the pair of strip-shaped cured layers (1) while moving the material deposition apparatus (2) with its wheels respectively abutting against the top of the pair of strip-shaped cured layers (1), wherein the second step is repeated to thereby construct the wall-like structure (100) including the pair of layered structural walls (10a and 10b) each having a structure in which strip-shaped cured layers are laid one on top of another.

### FIELD OF THE INVENTION

The present invention relates to a method for constructing a wall-like structure and a material deposition apparatus of a self-propelled type.

### BACKGROUND OF THE INVENTION

An apparatus called a 3D printer that produces a three-dimensional shaped object in which cured thin films are laid one on top of another by repeating a process (steps) in which a material for forming the three-dimensional shaped object is discharged in the same manner as printing ink to form a film, the film is cured to obtain a cured thin film, and then another film is formed on the cured thin film, is conventionally known. 3D printers have conventionally been used for many purposes such as prototyping of a component in the manufacturing industry, but they have come to be used to produce even a final product or a component. In recent years, the fields of application for 3D printers have been increasing, including the fields of medicine and architecture, and application to the field of architecture has also been reported.

An example of related art is described on a web page, Large Scale 3D Printing, [online], The Institute for Advanced Architecture of Catalonia (IAAC), [retrieved on Feb. 23, 2018], retrieved from the Internet <URL:https://iaac.net/research-projects/large-scale-3d-printing/minibuilders/>.

A common 3D printer includes a nozzle, which is a portion from which a material is extruded, a head, which is a portion on which the nozzle is mounted, a stage, which is a base on which a wall-like structure is to be constructed, and the like. A conventional architectural 3D printer also makes use of a similar mechanism.

However, with a 3D printer that has such a mechanism, the size of a wall-like structure that can be produced is limited depending on the size of the stage and the range of motion of the head. Accordingly, in a case where a large-scale wall-like structure or the like, such as a building, is to be produced, the limited size of the stage and the limited range of motion of the head become factors that reduce design flexibility. Moreover, existing technologies necessitate constructing a mechanism for construction prior to the construction of a building, and are therefore difficult to use in a narrow site or a site that has an irregular shape.

Moreover, a technology that produces a wall-like structure having a layered structure formed of a cured curable material using a self-propelled type material deposition apparatus that is equipped with a nozzle from which a material is extruded and that circulates while discharging the curable material has been proposed (the web page, Large Scale 3D Printing, [online], The Institute for Advanced Architecture of Catalonia (IAAC), [retrieved on Feb. 23, 2018], retrieved from the Internet <URL:https://iaac.net/research-projects/large-scale-3d-printing/minibuilders/>).

However, there are the following problems. A wall-like structure produced by this technology has a small thickness, and it is difficult to increase the size thereof due to insufficient strength. Also, if the thickness of the wall-like structure is increased, the material costs will increase.

The present invention relates to a method for constructing a wall-like structure with which wall-like structures that have various thicknesses can be easily constructed, and a high degree of design flexibility can be achieved, as well as a self-propelled type material deposition apparatus that can be suitably used in the aforementioned method.

### SUMMARY OF THE INVENTION

The present invention provides a method for constructing a wall-like structure using a self-propelled type material deposition apparatus.

The wall-like structure includes a pair of layered structural walls that are spaced apart from each other and that have a structure in which strip-shaped cured layers are laid.

The method of the present invention includes:

a first step of forming a pair of strip-shaped cured layers, which correspond to the pair of layered structural walls, by
discharging a curable material from two mutually spaced-apart portions of the material deposition apparatus that is moving, and
   curing the discharged curable material; and

a second step of forming a new second strip-shaped cured layer on each of the pair of strip-shaped cured layers by
discharging the curable material onto each of the pair of strip-shaped cured layers while moving the material deposition apparatus with wheels of the material deposition apparatus respectively abutting against the pair of strip-shaped cured layers, and
curing the curable material.

The second step is repeated to thereby construct the wall-like structure including the pair of layered structural walls each having a structure in which the strip-shaped cured layers are laid one on top of another.

Also, the present invention provides a self-propelled type material deposition apparatus including a first wheel and a second wheel that are spaced apart from each other in a perpendicular direction that is perpendicular to a moving direction; two nozzle portions that can deposit a curable material at two positions that are spaced apart from each other in the perpendicular direction; and an electric motor or an engine serving as a power source that drives the apparatus to move. Each of the first and second wheels has a tread that comes into contact with an upper surface of a strip-shaped cured layer that is formed as a result of the curable material being cured, and a deviation preventing flange portion that is formed on one side or both sides of the tread. The two nozzle portions are configured to be able to deposit the curable material on the upper surface of the strip-shaped cured layer with which the first wheel is in contact and the upper surface of the strip-shaped cured layer with which the second wheel is in contact, respectively.

### BRIEF DESCRIPTION OF THE DRAWINGS

FIG. 1 is a perspective view schematically showing an embodiment of a method for constructing a wall-like structure according to the present invention.

FIG. 2 is a perspective view showing an example of a self-propelled type material deposition apparatus that is used in the method for constructing a wall-like structure according to the present invention.

FIG. 3 is a front view of the material deposition apparatus shown in FIG. 2, when viewed from a front side in its advancing direction.

FIG. 4A is a perspective view of the material deposition apparatus shown in FIG. 2, when viewed from obliquely below, and FIG. 4B is an enlarged view of portion A in FIG. 4A.

FIG. 5 is a partially cross-sectional, perspective view showing the material deposition apparatus shown in FIG. 2.

FIGS. 6A and 6B schematically show other configurations of wheels of the material deposition apparatus.

FIGS. 7A to 7G are schematic plan views showing variations of the shape of a wall-like structure to be constructed in a plan view.

FIGS. 8A to 8G are schematic cross-sectional views showing variations of the vertical cross-sectional shape of a wall-like structure to be constructed.

FIG. 9 is a perspective view schematically showing another embodiment of the method for constructing a wall-like structure according to the present invention.

### DETAILED DESCRIPTION OF THE INVENTION

Hereinafter, the present invention will be described based on preferred embodiments thereof with reference to the drawings.

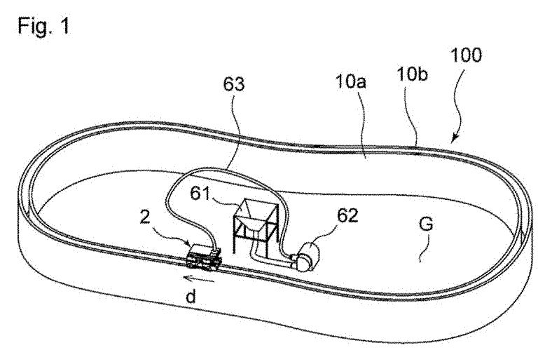

FIG. 1 is a perspective view schematically showing an embodiment of a method for constructing a wall-like structure according to the present invention.

In the method for constructing a wall-like structure according to the present invention, as shown in FIG. 1, for example, a wall-like structure 100 including a pair of layered structural walls 10a and 10b that are spaced apart from each other is constructed using a self-propelled type material deposition apparatus 2.

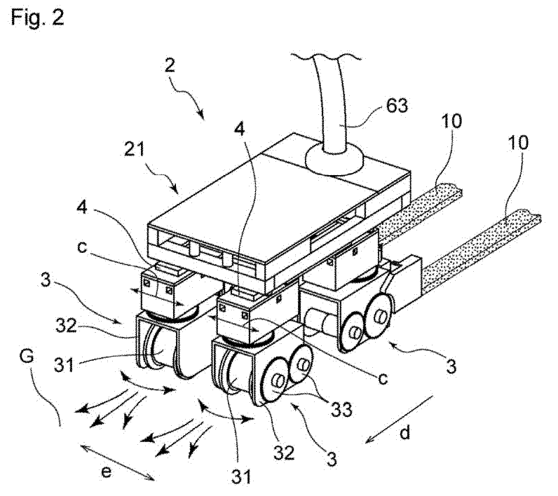

The pair of layered structural walls 10a and 10b included in the wall-like structure 100 are each formed by a curable material 10 being laid in multiple layers, the curable material 10 being discharged from two mutually spaced-apart portions of the self-propelled type material deposition apparatus 2 that is moving, as shown in FIG. 2. Each of the pair of layered structural walls 10a and 10b has a layered structure in which two or more, or preferably three or more, strip-shaped cured layers 1 formed as a result of the curable material 10 being cured are laid one on top of another. The number of strip-shaped cured layers 1 that are laid in each of the layered structural walls 10a and 10b included in the wall-like structure 100 can be determined as appropriate depending on the use, the required strength, the size, and the like of a wall-like structure to be constructed and is not limited to a specific number, but may be 3 to 100,000, for example, or preferably 5 to 10,000. The number of strip-shaped cured layers 1 that are laid per 10 cm of the height of each of the layered structural walls 10a and 10b can also be determined as appropriate depending on the use of the wall-like structure 100 to be constructed and the strength and the like required of the wall-like structure 100, and may be preferably 2 to 1,000 or more preferably 3 to 50 in a case where a wall of a building is to be constructed.

In a case where a wall of a building is built as the wall-like structure 100, for example, a building, such as a one-story building or an office building, can be completed by adding a roof, a floor of each story, and the like made of various known materials to the constructed wall-like structure 100. The wall-like structure 100 can also be constructed as a wall of an unroofed building, a nonstructural member of a building, or a member for applying a civil engineering, instead of a wall of a roofed building. Examples of the unroofed building include an outdoor structure of a building, a wall of a chimney, a wall around a park, a foundation of a fence, and the like. In a case where a wall of a building is to be formed, it is preferable that a cover (not shown) made of any material is disposed on upper ends of the pair of layered structural walls 10a and 10b, straddling both of the layered structural walls 10a and 10b. Examples of the material of the cover include concrete, mortar, a geopolymer composition, ceramic, metal, and a composite material of one or more of these materials.

In the wall-like structure 100 that is constructed according to the present invention, the pair of layered structural walls 10a and 10b may extend over the entire region of the wall-like structure 100 in the height direction, or the pair of layered structural walls 10a and 10b may account for only a portion of the wall-like structure 100 in the height direction.

The height of the pair of layered structural walls 10a and 10b is not limited, and can be determined as appropriate depending on the use and the like of the wall-like structure 100 to be produced. For example, the method and the apparatus according to the present invention can be used to produce, for example, a building with a height of 1 m to 500 m, or preferably a building with a height of 2 to 100 m. Moreover, the wall thickness of the wall-like structure 100 including the pair of layered structural walls 10a and 10b can also be determined as appropriate depending on the use, the design, and the like of the wall-like structure 100 to be produced, and is not limited. For example, the method and the apparatus according to the present invention can be used to produce, for example, a wall-like structure with a wall thickness of 8 cm to 10 m, or preferably a wall-like structure with a wall thickness of 10 cm to 2 m. “Wall thicknesses” as used herein refers to the distance between one of outer surfaces of the wall-like structure 100 and the other outer surface, and the thickness of a portion with the largest wall thickness if the wall-like structure 100 has portions with different wall thicknesses along the vertical direction or a moving direction of the material deposition apparatus.

Examples of the curable material that is used in the present invention include, but is not limited to, a civil engineering and construction material such as concrete, mortar, or a geopolymer composition, a molten thermoplastic resin or a thermosetting resin prior to thermosetting, or a mixture in which various types of aggregates are mixed in such a resin. Examples of curable materials that are civil engineering and construction materials include concrete, mortar, a geopolymer composition, and the like. Base materials of concrete are cement, water, a fine aggregate, and a coarse aggregate, and base materials of mortar are cement, water, and a fine aggregate. Various types of known admixtures such as an AE agent and a water-reducing agent may be mixed in the cement and the mortar as desired. Portland cement, for example, may be used as the cement. Sand and water-granulated slag with small grain sizes, for example, may be used as the fine aggregate, and gravel and water-granulated slag with relatively large grain sizes, for example, may be used as the coarse aggregate. The geopolymer composition is cured by a polycondensation reaction between an alumina-silica powder and an alkaline solution. Fly ash, ground granulated blast-furnace slag, and the like can be used as the alumina-silica powder, and a mixture of water glass and caustic soda and the like can be used as the alkaline solution. In addition to the alumina-silica powder and the alkaline solution, the geopolymer composition may also contain known aggregates and the like that are used in concrete and mortar.

A self-propelled type material deposition apparatus is used in the method for constructing a wall-like structure according to the present invention. In this specification, the self-propelled type material deposition apparatus is also referred to as a “self-propelled material deposition apparatus” or a “material deposition apparatus”.

The self-propelled material deposition apparatus has a self-propelling function and a function of depositing the curable material, and can form a pair of strip-shaped cured layers while moving on the previous strip-shaped cured layers that are formed as a result of the deposited curable material being cured. “Self-propelling” as used with respect to the self-propelled material deposition apparatus at least means that the apparatus is equipped with a power source such as an electric motor or an engine and can move by itself without requiring an external force applied from the outside, and it is preferable that the self-propelled material deposition apparatus travels along a predetermined two- or three-dimensional route that is set in advance so that a plurality of layered structural walls that are shaped as designed can be formed, based on a movement control signal that is input from an outside controller or a movement control signal that is output from a controller incorporated in the material deposition apparatus.

FIG. 2 shows a preferred example of the self-propelled type material deposition apparatus that is used in the method for constructing a wall-like structure according to the present invention. The material deposition apparatus shown in FIG. 2 also is a preferred embodiment of the material deposition apparatus according to the present invention. Hereinafter, the material deposition apparatus 2 shown in FIG. 2, which is suitably used in the method according to the present invention and is a preferred embodiment of the material deposition apparatus according to the present invention, will be referred to simply as the material deposition apparatus 2 and described more specifically.

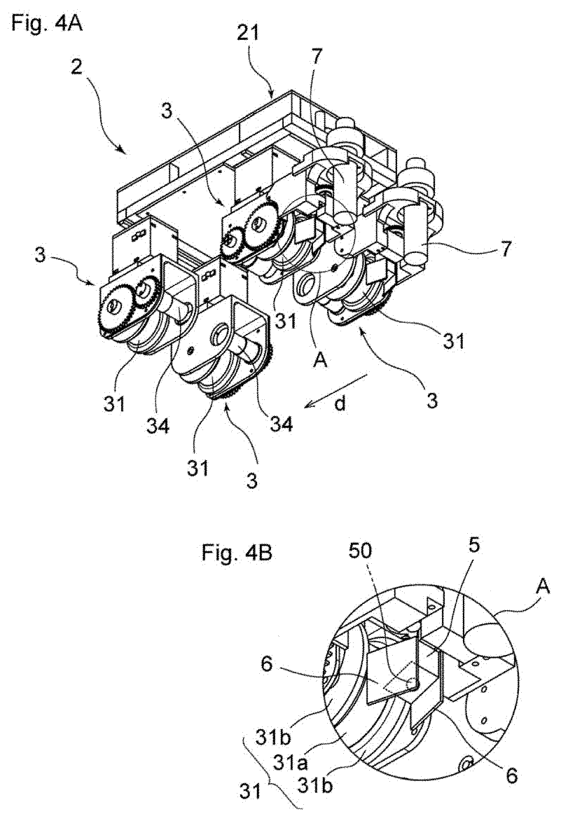

As shown in FIG. 2, the material deposition apparatus 2 includes an apparatus main body 21 and a plurality of leg portions 3 attached to the apparatus main body 21, and a wheel 31 is attached to each of the plurality of leg portions 3. More specifically, as shown in FIGS. 4A and 4B, the material deposition apparatus 2 includes a total of four leg portions 3, two on the front side and two on the rear side of the apparatus main body 21 in a moving direction “d”, and has a pair of wheels 31 on each of the front and rear sides in the moving direction “d”.

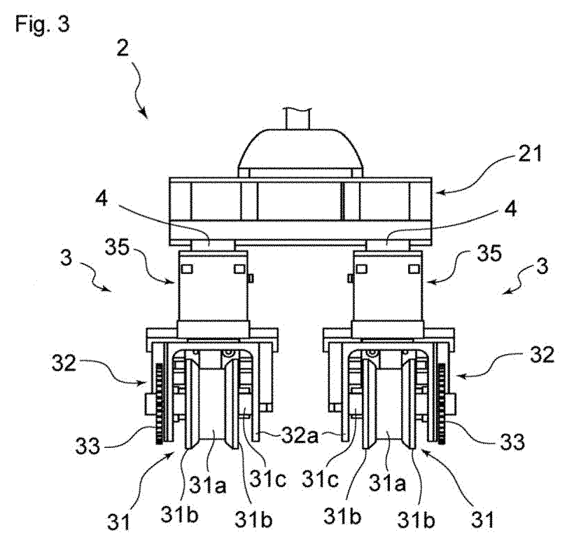

As shown in FIG. 3, a rotating shaft 31c of each wheel 31 is rotatably supported by a wheel holder 32a of a wheel holding unit 32 that is provided in a lower portion of the corresponding leg portion 3, and is connected to a servomotor 34, which is a power source and also is provided in the wheel holding unit 32, via a power transmission system constituted by a plurality of gears 33 and the like. Thus, the wheel 31 is configured to be rotated by a driving force from the servomotor 34. An electric motor, an engine, or the like other than a servomotor can also be used as the power source for rotating the wheel 31; however, it is preferable to use the servomotor 34, in particular, a servomotor equipped with an encoder, because this makes it possible to accurately control the moving speed and the moving distance.

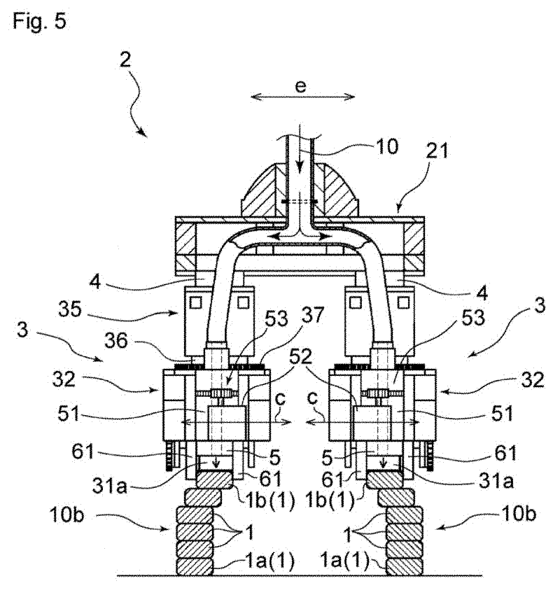

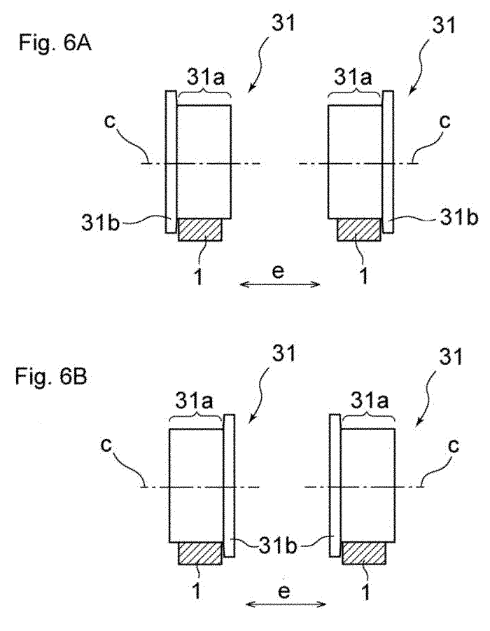

Moreover, as described above, the material deposition apparatus 2 has the pairs of wheels 31 on the front side and the rear side, respectively, in its moving direction “d”, and each of the wheels 31 has, as shown in FIGS. 3, 4A and 4B, a tread 31a and flange portions (deviation preventing flange portions) 31b for preventing deviation of the wheel, the flange portions 31b being formed on both sides of the tread 31a. As shown in FIGS. 3 and 5, the tread 31a is a portion that comes into contact with an upper surface of corresponding one of a pair of strip-shaped cured layers 1b when the material deposition apparatus 2 moves on the pair of strip-shaped cured layers 1b that are formed as a result of the curable material being cured. With regard to the flange portions 31b of the wheels 31, other configurations are also possible in which, as shown in FIGS. 6A and 6B, a flange portion 31b is provided on only one side of each wheel 31 in an axial length direction “c” of the rotating shaft. The use of a wheel 31 that has a flange portion 31b on one or both sides of the tread 31a as a first wheel and a second wheel that are spaced apart from each other in a perpendicular direction “e” that is perpendicular to the moving direction “d”, or preferably as all of the wheels 31, prevents the deviation of the wheels 31, stabilizes the movement of the material deposition apparatus 2, and makes it easy to control movement, such as the advancing direction of the material deposition apparatus 2, and construct a wall-like structure 100 that has a desired shape. Moreover, it is also possible that the side on which a flange portion 31b is provided is different between the pair of wheels on the front side in the moving direction “d” and the pair of wheels on the rear side, or the side on which a flange portion 31b is provided is different between the wheels that are located on one side in the perpendicular direction that is perpendicular to the moving direction “d” and the wheels that are located on the other side.

Moreover, in the material deposition apparatus 2, the distance between the wheels 31 that are spaced apart from each other in the perpendicular direction “e”, which is perpendicular to the moving direction “d”, as shown in FIG. 2, or more specifically, the distance between a wheel 31 (hereinafter also referred to as “first wheel”) that abuts against one of the pair of strip-shaped cured layers 1b and a wheel 31 (hereinafter also referred to as “second wheel”) that abuts against the other strip-shaped cured layer 1b, as shown in FIG. 5, can be increased or reduced. In the material deposition apparatus 2, the distance between the first wheel and the second wheel can be increased or reduced in both the state in which the movement of the material deposition apparatus 2 is stopped and the state in which it is moving. As a mechanism for achieving this purpose, sliding mechanisms 4 that slide the respective leg portions 3 in a direction “e” that is the same as the width direction of the apparatus main body 21 are disposed between the apparatus main body 21 and the respective wheels 31, or more specifically, in connecting portions between the apparatus main body 21 and the respective leg portions 3. The width direction of the apparatus main body 21 corresponds to the direction that is perpendicular to the moving direction of the material deposition apparatus 2.

For example, a mechanism including a slide guide such as a guide rail, a slider that travels along the slide guide, and an actuator that causes the slider to travel can be used as each sliding mechanism 4. With regard to the slide guide and the slider, the slide guide may be fixed to the apparatus main body 21 and the slider to the leg portion 3 side, or vice versa. Various commercially-available actuators can be used as the actuator, and examples thereof include electric actuators, such as a servomotor, a stepping motor, and a linear DC motor, hydraulic actuators such as a hydraulic cylinder, pneumatic actuators such as a pneumatic cylinder, and the like. As a sliding mechanism, a commercially-available linear actuator into which a slide guide, a slider, and an actuator are integrated, or a linear actuator in which a linear motor is used can also be employed. Directions in which the individual leg portions 3 and wheels 31 are slid may also be at an angle to the direction that is perpendicular to the moving direction “d”.

The actuator that moves one or both of the first and second wheels is operated based on a distance control signal that is input from the outside controller or a distance control signal that is output from the controller incorporated in the material deposition apparatus, and thus, even in a state in which the material deposition apparatus is moving, it is possible to perform control so as to increase or reduce the distance between the wheels that are spaced apart from each other in the perpendicular direction “e” that is perpendicular to the moving direction “d” (the distance between the first wheel and the second wheel).

Note that in a case where a pair of wheels are provided on each of the front and rear sides in the moving direction “d” like those of the material deposition apparatus 2, it is preferable to substantially simultaneously increase or reduce the distance between the pair of wheels on the front side and the distance between the pair of wheels on the rear side. Moreover, when increasing or reducing the distance between the wheels that are spaced apart from each other in the perpendicular direction “e” that is perpendicular to the moving direction “d” (the distance between the first wheel and the second wheel), it is preferable to symmetrically increase or reduce the distances to the respective wheels from a reference position that is set at any position, for example, a middle position, in the width direction of the apparatus main body 21, in light of the stable movement of the material deposition apparatus 2, and the like.

Moreover, as shown in FIG. 2, the material deposition apparatus 2 has a steering function of laterally changing the orientation of the pair of wheels 31 that are located on the front side in the moving direction “d” and the pair of wheels 31 that are located on the rear side. More specifically, each of the above-described wheel holding units 32 is connected to the apparatus main body 21 via an intermediate unit 35 that is located between the apparatus main body 21 and the wheel holding unit 32, and the wheel holding unit 32 is rotatably coupled to the intermediate unit 35. More specifically, the intermediate unit 35 and the wheel holding unit 32 are connected to each other via a rotating shaft 36 that enables the rotation of the wheel holding unit 32, and, furthermore, the wheel holding unit 32 is rotated about the rotating shaft 36 by a gear 37 fixed on the wheel holding unit 32 being rotated by a driving gear that is rotated by a servomotor (not shown) provided in the intermediate unit 35, so that the orientation of the wheel 31 that is held by the wheel holding unit 32 can be changed to a straight forward direction, a rightward direction, a leftward direction, or the like as shown in FIG. 2.

The rotation and the angle of rotation of the servomotor (not shown) provided in the intermediate unit 35 are controlled based on an advancing direction control signal that is input from the outside controller or an advancing direction control signal that is output from the controller incorporated in the material deposition apparatus. In this manner, in either of the state in which the movement of the material deposition apparatus is stopped and the state in which it is moving, the orientation of the wheels 31 can be changed to any of the directions in which the material deposition apparatus 2 moves straight forward, turns to the right, and turns to the left, by rotating the wheel holding units 32.

Note that in a case where a pair of wheels are provided on each of the front and rear sides in the moving direction “d” like those of the material deposition apparatus 2, although a configuration may be adopted in which the orientation of only either the pair of wheels on the front side or the pair of wheels on the rear side can be changed, it is preferable that the orientation of at least the pair of wheels on the front side can be changed, and it is preferable that the orientation of both the pair of wheels on the front side and the pair of wheels on the rear side can be changed.

Moreover, as described above, the material deposition apparatus 2 has the function of depositing the curable material. Specifically, as shown in FIG. 2, the material deposition apparatus 2 has nozzle portions 5 at two positions that are spaced apart from each other in the perpendicular direction “e” that is perpendicular to the moving direction “d”, and as shown in FIG. 5, the curable material 10 that is supplied to the material deposition apparatus 2 and that has fluidity is discharged from respective openings 50 that open downward, and thus, the curable material 10 can be deposited onto a base surface G on which no strip-shaped cured layer has yet been formed or onto respective strip-shaped cured layers 1a that have been formed as a result of the curable material being deposited on the base surface G and cured. Examples of the base surface G on which no strip-shaped cured layer has yet been formed include the ground and a surface formed by pouring concrete, mortar, asphalt, or the like on the ground.

An example of the method for supplying the curable material to the material deposition apparatus 2 is a method in which, as shown in FIG. 1, the curable material stored in a temporary storage portion that has a hopper 61 is pumped to the material deposition apparatus 2 via a pump 62 and a flexible tube 63 that connects the pump 62 to the material deposition apparatus 2; however, the present invention is not limited to this method, and any method can be employed. For example, in a case such as a wall-like structure to be built being relatively small, a method may be adopted in which a storage portion of the curable material is provided in the material deposition apparatus 2, and the curable material is supplied from the storage portion to the nozzle portions 5, and, furthermore, in that case, a replenishment station for replenishing the storage portion with the curable material may be provided in a portion on the track of the material deposition apparatus 2. In the case where the curable material is pumped to the material deposition apparatus 2 from the pump 62 via the tube 63, it is preferable that the tube 63 is connected via a rotary nipple or the like so that the tube 63 is rotatable relative to the apparatus main body 21.

A method for constructing a wall-like structure 100 including a pair of layered structural walls 10a and 10b that are spaced apart from each other, such as those shown in FIG. 1, using the above-described material deposition apparatus 2 will be described using an example. In order to construct the wall-like structure 100 including the pair of layered structural walls 10a and 10b that are spaced apart from each other, as a first step, as shown in FIG. 2, two strips of the curable material 10 are discharged from the two respective nozzle portions 5 onto the base surface G on which no strip-shaped cured layer has yet been formed, while appropriately changing the advancing direction of the material deposition apparatus 2 that is moving by changing one or both, or preferably both, of the orientation of the wheels 31 on the front side in the moving direction “d” and the orientation of the wheels 31 on the rear side, and thus, the curable material 10 is deposited on the base surface G. It is preferable that the curable material 10 is deposited in a state in which it has a certain degree of viscosity so that a pair of strip-shaped cured layers 1 that have a certain thickness can be formed. Then, while depositing the two strips of the curable material 10, the material deposition apparatus 2 is moved along a path that has the same shape as the shape of the wall-like structure 100 to be constructed in a plan view, and the deposited curable material is cured, to thereby form the pair of strip-shaped cured layers 1a that have the same shape in a plan view as the shape of the wall-like structure 100 in a plan view.

In a case where a wall-like structure that has a closed shape in a plan view is to be constructed, in the first step, the material deposition apparatus 2 is moved to a location at which the deposition of the curable material 10 has been started. Preferably, at the time when the material deposition apparatus 2 reaches the deposition starting location, the curable material that has been deposited in the previous lap has already been cured to such an extent that the material deposition apparatus 2 can move thereon, and if the curable material has not yet been cured, it is preferable to perform one or two or more of the following measures: the reduction of the moving speed of the material deposition apparatus 2, the adjustment of the curing speed of the curable material, a treatment for accelerating the curing of the curable material, and the like.

If the curable material 10 that has been deposited in the previous lap has already been cured to such an extent that the material deposition apparatus 2 can move thereon, the processing proceeds to a second step.

In the second step, the material deposition apparatus 2 is placed on a pair of strip-shaped cured layers 1a that have been formed as a result of the curable material being deposited in the first lap and cured, and the wheels 31 are respectively made to abut against the top of the pair of strip-shaped cured layers 1a. More specifically, the material deposition apparatus 2 is placed so that the tread 31a of one wheel 31 of a pair of wheels 31 that are spaced apart from each other in the width direction “e” of the material deposition apparatus 2 is placed on the upper surface of one of the strip-shaped cured layers 1a and the tread 31a of the other wheel 31 is placed on the upper surface of the other strip-shaped cured layer 1a. With regard to the method for placing the material deposition apparatus 2 on an immediately previous pair of strip-shaped cured layers 1a that have been formed by depositing the curable material in the immediately previous lap, it is preferable that the material deposition apparatus 2 moves onto those layers in a self-propelling manner. However, since the difference in level is likely to be large in the first step, the material deposition apparatus 2 may be lifted by hand and placed on the previous layers, or if the material deposition apparatus 2 is large-sized, it may be placed on the previous layers using an apparatus such as a forklift. Moreover, at the start of deposition, the thickness of the deposited curable material may be gradually increased so that a slope is formed at an end portion of each of the resulting strip-shaped cured layers.

Next, while the material deposition apparatus 2 moves with the wheels 31 of the material deposition apparatus 2 respectively abutting against the top of the pair of strip-shaped cured layers 1a, the material deposition apparatus 2 discharges the curable material on the strip-shaped cured layers 1a, and the curable material is cured. Thus, new strip-shaped cured layers 1 are formed on the respective strip-shaped cured layers 1a. Then, as shown in FIG. 5, the second step is repeated, to thereby construct the wall-like structure 100 including the pair of layered structural walls 10a and 10b that each have a structure in which multiple strip-shaped cured layers 1 are laid one on top of another.

In the method for constructing a wall-like structure according to the present invention, it is preferable that the material deposition apparatus 2 circulates along a path that has a closed shape in a plan view three or more times, to thereby form layered structural walls 10a and 10b that each have a layered portion in which three or more strip-shaped cured layers 1 are laid one on top of another, as the layered structural walls 10a and 10b. The upper limit of the number of times the material deposition apparatus 2 circulates is not limited, and may be 100,000 or less, for example.

With the above-described embodiment of the method for constructing a wall-like structure according to the present invention, while the material deposition apparatus 2 moves on strip-shaped cured layers 1 formed of the curable material that the material deposition apparatus 2 itself has previously deposited, the material deposition apparatus 2 can form the next strip-shaped cured layers 1 on the previous strip-shaped cured layers 1, and the wall-like structure 100 including the pair of layered structural walls 10a and 10b can be formed by repeating this operation. Accordingly, the limits of the construction area can be lessened, and the shape of the wall-like structure 100 can be freely determined, so that design flexibility with respect to the shape of the wall-like structure 100 can be improved.

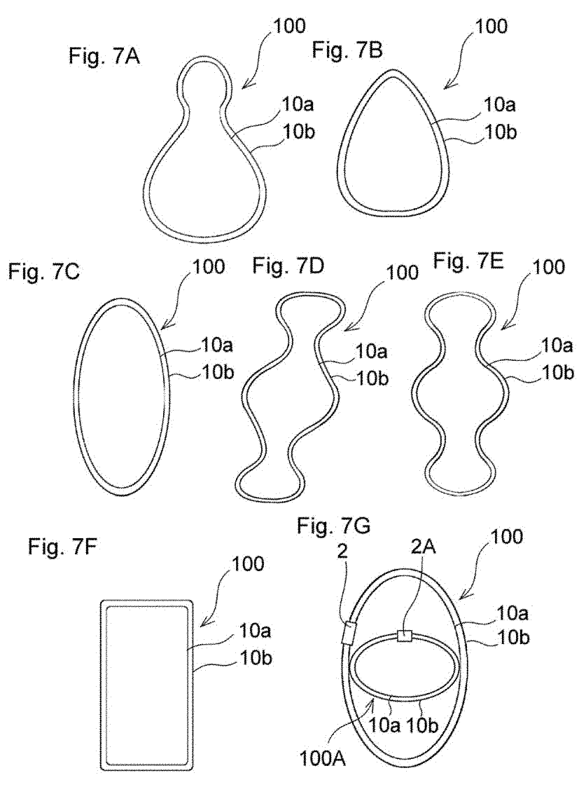

FIGS. 7A to 7F show examples of the shape of the wall-like structure 100 that is constructed according to the present invention in a plan view. As shown in FIGS. 7A to 7F, with the method and the apparatus according to the present invention, wall-like structures 100 that have various shapes in a plan view can be formed. Moreover, although it is preferable that the material deposition apparatus 2 circulates along a path that has a closed shape in a plan view, the present invention is not limited to this. Moreover, although the closed shape that the material deposition apparatus 2 follows in a plan view may be a circle, it is preferable that this closed shape is a noncircular shape, because a wall-like structure 100 that has a noncircular shape in a plan view and has excellent design quality and the like can be obtained. It is preferable that the path that the material deposition apparatus 2 follows and the shape of the wall-like structure 100 in a plan view include a plurality of circular arc-shaped portions that have different radii of curvature or curving directions. FIGS. 7A to 7E show such examples. Having a portion in which circular arc-shaped portions that have different curving directions are successively formed is advantageous in that the wall-like structure 100 is structurally stabilized.

Moreover, the advancing direction of the material deposition apparatus 2 can be changed by changing the orientation of the wheels 31, and as shown in FIG. 2, in the first step, it is possible to form a pair of strip-shaped cured layers 1a that constitute the track of the material deposition apparatus 2 in the next lap on the base surface G on which no strip-shaped cured layer has yet been formed, while controlling the advancing direction of the material deposition apparatus 2 that is moving. This eliminates the need to preliminarily form a structure or the like that serves as a guide along which the material deposition apparatus 2 moves. Accordingly, preparatory operations that should be performed prior to the construction of the wall-like structure 100 can be reduced.

In order that, when the material deposition apparatus 2 circulates and returns to the deposition starting location, the material deposition apparatus 2 can mount onto a previously deposited and formed pair of strip-shaped cured layers in a self-propelling manner, or in order to accurately control the track along which the material deposition apparatus 2 moves and accurately construct a wall-like structure as designed, it is preferable to continuously collect and monitor data of moving conditions such as the position, the orientation, and the travelling speed of the material deposition apparatus 2 that is moving, using various known tracking technologies, and move the material deposition apparatus 2 while modifying the moving conditions and the like based on the data. For example, it is preferable that the present position of the material deposition apparatus 2 that is moving in a self-propelling manner is detected on a three-dimensional coordinate system using a known tracking system, an expected position after a predetermined period of time is calculated from the information on the detected present position and the moving conditions, such as the advancing direction and the speed, at that point in time, and the material deposition apparatus 2 is moved while modifying the moving conditions so as to reduce the difference between the expected position and an ideal position, to thereby enable the material deposition apparatus 2 to move along an optimum route that is set in order to form a wall-like structure to be obtained. Examples of the known tracking technologies include a tracking system that is incorporated in a VR head mounted display HTC Vive for PCs, from HTC Corporation, and a plurality of the aforementioned tracking systems that are linked together. In that case, it is preferable that sensors are provided at a plurality of portions in the material deposition apparatus 2 so that the orientation of the material deposition apparatus 2 can also be detected.

Moreover, in the above-described material deposition apparatus 2, as shown in FIG. 5, the distance between the two nozzle portions 5 that are spaced apart from each other in the perpendicular direction “e” perpendicular to the moving direction “d” can be increased or reduced in a state in which the material deposition apparatus 2 is moving. In the material deposition apparatus 2, as a mechanism that can increase or reduce the distance between the two nozzle portions 5 in a state in which the material deposition apparatus 2 is moving, for example, a mechanism can be used which includes holders (not shown) that each support a nozzle unit 51 having corresponding one of the nozzle portions 5 at a lower end thereof, in such a manner that the nozzle unit 51 is slidable along the axial length direction “c” of the rotating shaft of the wheel 31 relative to the wheel holding unit 32 of the leg portion 3 on the rear side in the moving direction, and actuators 53 that each move corresponding one of the nozzle units 51 supported by the respective holders to a predetermined position in the axial length direction “c”. Various commercially-available actuators can be used as the actuators 53, and examples thereof include electric actuators such as a servomotor, a stepping motor, and a linear DC motor, hydraulic actuators such as a hydraulic cylinder, and pneumatic actuators such as a pneumatic cylinder. In FIG. 5, actuators that each include a servomotor (not shown) that is fixed in a box 52 fixed to the wheel holding unit 32, a pinion that is rotated by the servomotor, and a rack that engages with the pinion are shown as the actuators 53, and each nozzle unit 51 and the nozzle portion 5 attached to the nozzle unit 51 can be moved to any position in the axial length direction “c” of the rotating shaft of the wheel 31 by controlling the angle of rotation of the servomotor.

The positions of the nozzle units 51 relative to the respective wheel holding units 32, which hold the respective wheels 31, can be changed by the actuators 53. Thus, with the material deposition apparatus 2, by operating the actuators 53 based on an advancing direction control signal that is input from the outside controller or an advancing direction control signal that is output from the controller incorporated in the material deposition apparatus, it is possible, in both the state in which the movement of the material deposition apparatus is stopped and the state in which the material deposition apparatus is moving, to shift the position of one or both of the two nozzle portions 5 that are spaced apart from each other in the perpendicular direction “e” perpendicular to the moving direction “d”, in the same direction as the axial length direction “c” of the rotating shafts of the wheels 31, or in the perpendicular direction “e” perpendicular to the moving direction “d” of the material deposition apparatus 2, in relation to the positions of the wheels 31 held by the respective wheel holding units 32.

When a material deposition apparatus in which the distance between the wheel 31 that abuts against one of the pair of strip-shaped cured layers 1 and the wheel 31 that abuts against the other strip-shaped cured layer 1, and the distance between the two portions from which the curable material is discharged can be increased or reduced, is used as the material deposition apparatus 2, the wall thickness of the wall-like structure 100 to be constructed can be easily changed. Thus, a wall-like structure 100 that has a desired wall thickness depending on the purpose, use, or the like can be constructed, and various contrivances can be made: for example, in a case where a relatively large-sized wall-like structure 100 that has a large height is to be constructed, a lack of strength can be prevented by increasing the distance between a pair of layered structural walls, and in a case where a relatively small-sized wall-like structure 100 that has a small height is to be constructed, the size of an interior space can be increased by reducing the distance between a pair of layered structural walls. Moreover, in a case where a large-sized wall-like structure 100 that has a relatively large wall thickness is to be produced as well, a wall-like structure 100 that has an appropriate thickness (wall thickness) can be constructed while suppressing the amount of materials used and an increase in the material costs.

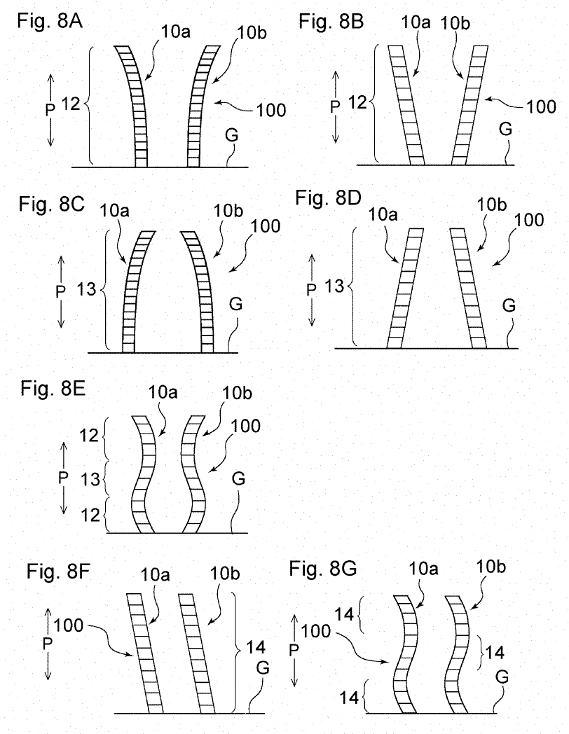

Furthermore, when a material deposition apparatus in which the distance between the wheel 31 that abuts against one of the pair of strip-shaped cured layers 1 and the wheel 31 that abuts against the other strip-shaped cured layer 1, and the distance between the two portions from which the curable material is discharged can be increased or reduced in a state in which the material deposition apparatus is moving, is used as the material deposition apparatus 2, the distance between the wheels 31 and the distance between the strip-shaped cured layers 1 to be formed can be increased or reduced in a state in which the material deposition apparatus is moving. Thus, as shown in FIGS. 8A, 8B, and 8E, a wall-like structure that has a portion 12 in which the distance between the pair of layered structural walls 10a and 10b increases in an upward vertical direction P can be constructed as the wall-like structure 100, and as shown in FIGS. 8C, 8D, and 8E, a wall-like structure that has a portion 13 in which the distance between the pair of layered structural walls 10a and 10b decreases in an upward vertical direction P can also be constructed as the wall-like structure 100.

Furthermore, in the material deposition apparatus 2, the position of each of the two nozzle portions 5 in the perpendicular direction “e” that is perpendicular to the moving direction can be controlled using a reference position that is set at a predetermined position in the axial length direction “c” of the rotating shaft of the corresponding first or second wheel. Thus, the position of one or both of the nozzle portions 5 can be accurately shifted in relation to the corresponding wheels 31 in a state in which the material deposition apparatus 2 is moving, and a wall-like structure 100 that has a portion 12 in which the distance between the pair of layered structural walls 10a and 10b increases in an upward vertical direction P or a portion 13 in which the aforementioned distance decreases and that has excellent design quality and the like can be easily constructed.

Note that wall-like structures 100 that have vertical cross-sectional shapes taken in a direction perpendicular to a wall surface and shown in FIGS. 8F and 8G can also be constructed by gradually shifting the positions of the two nozzle portions 5 in the same direction relative to the respectively corresponding wheels 31. The wall-like structures 100 shown in FIGS. 8F and 8G have a portion 14 in which the pair of layered structural walls 10a and 10b are inclined in the same direction relative to the vertical direction P.

Moreover, it is preferable that a material deposition apparatus that is used in the method according to the present invention and the material deposition apparatus according to the present invention include a curing-accelerating means (for example, curing accelerator) for accelerating the curing of the curable material. Preferably, depending on the curable material used, a curing-accelerating means that can accelerate the curing of the curable material is selected and used. For example, for a curable material whose curing is accelerated through heating, various known heating means such as an electric wire heater, an infrared heater, and a hot air dryer can be preferably provided as the curing-accelerating means, and for a curable material whose curing is accelerated through cooling, various known cooling means such as an apparatus for spraying cold water or cold air can be preferably provided. Moreover, for a curable material whose curing is accelerated by ultraviolet rays or other energy rays, an irradiating apparatus of the relevant energy rays and the like can be preferably provided.

Moreover, with regard to the curing acceleration treatment using the curing-accelerating means, it is preferable that, while the material deposition apparatus is moving, the curable material 10 immediately after being deposited by the material deposition apparatus 2 is subjected to the curing acceleration treatment. FIGS. 4A and 4B show an example in which, in the above-described material deposition apparatus 2, in order that the curable material immediately after being deposited can be subjected to the curing acceleration treatment, heaters 7 serving as the curing-accelerating means are provided directly behind the respective nozzle portions 5 in the moving direction of the material deposition apparatus 2.

Moreover, as shown in FIG. 4B, a material deposition apparatus that is used in the method according to the present invention and the material deposition apparatus according to the present invention have a pair of forming plates 6 near the opening of each nozzle portion 5, the pair of forming plates 6 forming the shape of the discharged curable material. The pair of forming plates 6 are provided for the purposes of forming the discharged material and finishing a finish surface, and it is preferable that, as shown in FIG. 4B, the pair of forming plates 6 are arranged sandwiching a space in which the curable material is discharged from both sides, and extending rearward in the moving direction “d”, with the distance therebetween gradually decreasing rearward in the moving direction “d”. The width between the rearmost portions of the pair of forming plates 6 is approximately equal to the width of each layered structural wall to be formed. Providing the above-described forming plates 6 has the advantages of enabling the width of each layered structural wall to be kept constant and enabling smooth finishing of the wall. Note that it is preferable that the forming plates 6 each have a portion that is located above the upper surface of a strip-shaped cured layer 1b that has been cured and on which a corresponding wheel 31 is placed and a portion that is located below the aforementioned upper surface, and can make the position of one or both of the side surfaces of the strip-shaped cured layer 1b that has been cured and the position of one or both of the side surfaces of the curable material to be deposited coincide with each other.

Although the present invention has been described based on preferred embodiments thereof above, the present invention is not limited to the foregoing embodiments, and changes can be made thereto as appropriate.

For example, a wall-like structure to be constructed may also have another layered structural wall between the pair of layered structural walls on which the wheels are placed. For example, a configuration may also be adopted in which a nozzle portion that deposits a curable material one lap later while oscillating from side to side is provided between the pair of wheels that are spaced apart from each other in the direction that is perpendicular to the moving direction, and a wall-like structure that has a wave-shaped layered structural wall between the pair of layered structural walls like a corrugated cardboard is constructed.

Moreover, a configuration can also be adopted in which, between the pair of wheels that are spaced apart from each other in the direction perpendicular to the moving direction, a second nozzle portion that deposits a curable material without oscillating from side to side is provided, and a layered structure made of a different material than the curable material composing the pair of layered structural walls 10a and 10b is formed between the pair of layered structural walls 10a and 10b. The second nozzle portion may be provided at a position in the direction perpendicular to the moving direction where no wheel is located between the pair of wheels. A layered structure portion that is formed of the curable material discharged from the second nozzle portion may have a width spanning from one layered structural wall 10a of the pair of layered structural walls 10a and 10b to the other layered structural wall 10b, or a gap may be left between the layered structure portion and one or both of the layered structural walls 10a and 10b. In order that a difference in level is created between the aforementioned layered structure portion and the strip-shaped cured layers that form the upper ends of the pair of layered structural walls on which the wheels 31 are placed, it is preferable that, in a case where a wall-like structure is constructed by circulating the material deposition apparatus along an annular track, the curable material that is discharged from the second nozzle portion and forms the layered structure portion is deposited with a time difference such that, for example, the second nozzle portion starts the deposition of the curable material one or more laps later.

Moreover, after the completion of a pair of layered structural walls or during the construction thereof, another material such as, for example, a foamable resin composition serving as a heat insulator can also be injected between the pair of layered structural walls, or another material such as glass wool can also be filled therebetween. The other material that is filled between the pair of layered structural walls after the completion of the pair of layered structural walls or during the construction thereof may also be a curable material or the like, such as concrete. Between the “pair of layered structural walls that are spaced apart from each other” of the present invention, a layered structure made of a material that is different from the curable material that is deposited in order to form the pair of layered structural walls, or made of a curable material that is deposited at a timing different from the timing at which the curable material for forming the pair of layered structural walls is deposited, may also be formed.

Moreover, a wall-like structure that includes three or more layered structural walls including the pair of layered structural walls 10a and 10b can also be constructed by discharging a curable material from three or more portions (e.g., three to five portions) that are spaced from each other in the direction perpendicular to the moving direction of the material deposition apparatus that is moving in a self-propelling manner. In this case, layered structural walls that are located at both ends in the perpendicular direction that is perpendicular to the moving direction, of the layered structural walls that are formed by the material deposition apparatus with its wheels 31 abutting against the upper surfaces thereof, are regarded as being the pair of layered structural walls 10a and 10b.

Moreover, it is also possible that, when forming an annular wall-like structure by circulating the material deposition apparatus, a curable material that can form a water-soluble cured layer is cyclically deposited as a curable material to be deposited at a specific position in the circumferential direction, to thereby construct a wall-like structure that partly has a layered structure in which water-soluble cured layers are laid one on top of another, and then a layered portion in which water-soluble cured layers are laid one on top of another is dissolved or broken with water to form an opening in the wall-like structure.

Moreover, it also possible that two material deposition apparatuses are made to circulate at a predetermined distance from each other, and a single wall-like structure is constructed from a curable material deposited by the two material deposition apparatuses. Moreover, as shown in FIG. 7G by way of example, it is also possible to form an annular wall-like structure 100 formed by one material deposition apparatus 2 and an annular wall-like structure 100A formed by another material deposition apparatus 2A in close proximity with each other and thereby construct a building that has a partition wall.

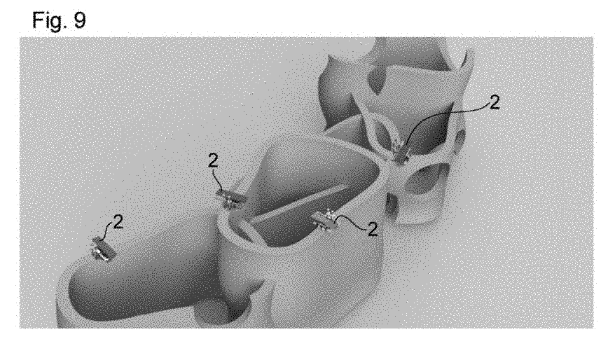

Moreover, as shown in FIG. 9, during construction of a building, the method and the apparatus according to the present invention can also be used in a method for constructing a building in which a building is constructed using a plurality of self-propelled type material deposition apparatuses. This also contributes to a reduction of the construction period due to the plurality of material deposition apparatuses individually constructing separate sections at the same time. The number of self-propelled type material deposition apparatuses that are allowed to move at the same time during construction of a single building can be set at 2 to 100, for example, or preferably 2 to 20, but is not limited to a specific number.

The wall-like structure according to the present invention is not limited to one for architecture, but has various uses. For example, the wall-like structure according to the present invention may be a whole of or a part of an equipment, an interior or a material, which is to be arranged inside a building, such as: a support for a top board of a sink; chair itself; and a support for a back plate of a chair. The wall-like structure may be also a civil engineering structure such as; a height or wall which is used for separating pedestrians and vehicles and which is to be arranged between a sidewalk and a roadway; a base portion of a safety fence; a height or wall which is to be provided on a median. The wall-like structure may be a whole of or a part of an artwork. The wall-like structure may be unseparatably or hardly-separatably fixed to a ground or a floor where the wall-like structure is constructed, or may be separatably fixed to a ground or a floor where the wall-like structure is constructed. Also, the wall-like structure is formed on a support that which is formed without using the method and the apparatus according to the present invention.

Note that the outside controller or the controller incorporated in the material deposition apparatus 2 preferably includes a display unit, an input unit, a storage device, a central processing unit, an internal timer, and the like that are included in a general-purpose computer. The display unit is configured by, for example, an LCD (Liquid Crystal Display), a CRT (Cathode-Ray Tube), an EL display (Electroluminescence display), or the like, and the input unit is configured by, for example, a keyboard, a touch panel, an interface to which an external memory such as an USB is connectable, or the like. The storage device is configured by a ROM (Read Only Memory), a RAM (Random Access Memory), an HDD (Hard Disk Drive), an SSD (solid state drive), or the like, and the central processing unit is configured by a CPU (Central Processing Unit) or the like. The display unit, the input unit, the storage device, the central processing unit, and the like of a computer together function as a controller of the material deposition apparatus 2 by being linked with each other and operated by an OS (Operating System) installed in the computer and a piece of application software running on the OS, and output the above-described movement control signal, advancing direction control signal, distance control signal, and the like to the material deposition apparatus 2 based on CAD data and the like of a wall-like structure to be obtained, so that the material deposition apparatus 2 is located at an appropriate position in an appropriate state at an appropriate timing.

In a case where a controller that outputs a movement control signal is provided outside, the material deposition apparatus preferably includes a receiver that receives various signals output from the controller via wireless transmission or wired transmission and an auxiliary controller that drives the various units in an appropriate order based on the received signals. For the wireless transmission, any communication method such as infrared communication or Wi-Fi can be employed. Although it is preferable that the material deposition apparatus is equipped with any power supply that supplies power to the electric motor and the controller, power can also be supplied from the outside via wiring. Examples of such power supply include a secondary batter, a fuel cell, and a non-rechargeable battery, and examples of the secondary battery include a NaS battery, a lithium-ion battery, a lead battery, and a nickel-metal hydride battery.

Moreover, the material deposition apparatus 2 shown in FIGS. 2 and 4A is a four-wheel drive apparatus, and although this configuration is preferable, a material deposition apparatus that is moved by driving only the two wheels on the front side or the two wheels on the rear side may also be used.

Moreover, a configuration may also be adopted in which, in the material deposition apparatus 2 according to the present invention, the distance between the wheels can be adjusted so as to be increased or reduced in a state in which the material deposition apparatus is not moving, but the distance between the wheels cannot be adjusted so as to be increased or reduced in a state in which the material deposition apparatus is moving. Wall-like structures that have different wall thicknesses can be produced by adjusting the distance between the wheels before the material deposition apparatus moves.

### INDUSTRIAL APPLICABILITY

With the method for constructing a wall-like structure according to the present invention, a wall-like structure with a desired thickness or a wall-like structure with a desired shape in a plan view can be constructed, and design flexibility with respect to a relatively large-sized wall-like structure can be increased.

With the self-propelled type material deposition apparatus according to the present invention, a wall-like structure including a plurality of layered structural walls that each have a layered structure in which strip-shaped cured layers formed of a curable material that has been cured are laid one on top of another can be stably and efficiently constructed.

1. A method for constructing a wall-like structure using a self-propelled type material deposition apparatus the wall-like structure including a pair of layered structural walls that are spaced apart from each other and that have a structure in which strip-shaped cured layers are laid, the method comprising:
a first step of forming a pair of strip-shaped cured layers, which correspond to the pair of layered structural walls, by
discharging a curable material from two mutually spaced-apart portions of the material deposition apparatus that is moving, and
curing the discharged curable material; and
a second step of forming a new strip-shaped cured layer on each of the pair of strip-shaped cured layers by
discharging the curable material onto each of the pair of strip-shaped cured layers while moving the material deposition apparatus with wheels of the material deposition apparatus respectively abutting against the pair of strip-shaped cured layers, and
curing the curable material,
wherein the second step is repeated to thereby construct the wall-like structure including the pair of layered structural walls each having a structure in which the strip-shaped cured layers are laid one on top of another.

2. The method for constructing a wall-like structure according to claim 1,
wherein, as the material deposition apparatus, a material deposition apparatus in which the distance between a wheel that abuts against one of the pair of strip-shaped cured layers and a wheel that abuts against the other strip-shaped cured layer, as well as the distance between the two portions from which the curable material is discharged can be increased or reduced in a state in which the material deposition apparatus is moving is used.

3. The method for constructing a wall-like structure according to claim 1,
wherein, as the wall-like structure to be constructed, a wall-like structure that has a portion in which the distance between the pair of layered structural walls increases or decreases in an upward vertical direction is constructed.

4. The method for constructing a wall-like structure according to claim 1,
wherein, as the material deposition apparatus, a material deposition apparatus whose advancing direction can be changed by changing the orientation of the wheels is used, and in the first step, the pair of strip-shaped cured layers are formed on a base surface on which no strip-shaped cured layer has yet been formed, while controlling the advancing direction of the material deposition apparatus that is moving.

5. The method for constructing a wall-like structure according to claim 1,
wherein the material deposition apparatus circulates along a path that has a closed shape in a plan view three or more times, and, as the layered structural walls, layered structural walls that each have a layered portion in which three or more of the strip-shaped cured layers are laid one on top of another.

6. The method for constructing a wall-like structure according to claim 5,
wherein the closed shape in a plan view is a noncircular shape.

7. The method for constructing a wall-like structure according to claim 1,
wherein a curable material whose curing is accelerated through a predetermined treatment is used as the curable material, and a material deposition apparatus including a curing accelerator for the curable material is used as the material deposition apparatus.

8. The method for constructing a wall-like structure according to claim 1,
wherein the curable material is discharged from three or more portions that are spaced apart from each other in a direction that is perpendicular to a moving direction of the material deposition apparatus that is moving in a self-propelled manner, to thereby construct the wall-like structure that includes three or more layered structural walls including the pair of layered structural walls.

9. A self-propelled type material deposition apparatus comprising:
a first wheel and a second wheel that are spaced apart from each other in a perpendicular direction that is perpendicular to a moving direction;
two nozzle portions that can deposit a curable material at two positions that are spaced apart from each other in the perpendicular direction; and
an electric motor or an engine serving as a power source that drives the apparatus to move,
wherein each of the first wheel and the second wheel has: a tread that comes into contact with an upper surface of a strip-shaped cured layer that is formed as a result of the curable material being cured; and a deviation preventing flange portion that is formed on one side or both sides of the tread, and
the two nozzle portions are configured to be able to deposit the curable material on the upper surface of the strip-shaped cured layer with which the first wheel is in contact and the upper surface of the strip-shaped cured layer with which the second wheel is in contact, respectively.

10. The material deposition apparatus according to claim 9,
wherein the distance between the first wheel and the second wheel can be increased or reduced in a state in which the material deposition apparatus is moving, and
the distance between the two nozzle portions can be increased or reduced in a state in which the material deposition apparatus is moving.

11. The material deposition apparatus according to claim 10,
wherein the position of one or both of the two nozzle portions in the perpendicular direction can be controlled relative to a reference position that is set at a predetermined position in a direction of a rotating shaft of the corresponding first or second wheel.
